(19) United States
(12) Patent Application Publication
(10) Pub. No.: US 2024/0336841 A1
(43) Pub. Date: Oct. 10, 2024

(54) REDUCING PARTICLE DISPERSION

(71) Applicant: MITSUBISHI PENCIL COMPANY, LIMITED, Tokyo (JP)

(72) Inventor: Hisato HAGA, Tokyo (JP)

(73) Assignee: MITSUBISHI PENCIL COMPANY, LIMITED, Tokyo (JP)

(21) Appl. No.: 18/690,892

(22) PCT Filed: Sep. 24, 2021
(86) PCT No.: PCT/JP22/34038

§ 371 Date: Mar. 11, 2024

(30) Foreign Application Priority Data
Sep. 24, 2021 (JP) 2021-155390
Nov. 12, 2021 (JP) 2021-185070

(51) Int. Cl. C09K 15/24

(52) U.S. Cl. CPC C09K 15/24

(57) ABSTRACT

A reducing particle dispersion may achieve both reduction performance on oxygen (oxygen absorbing ability) and preservative performance at a high level, while not adversely affecting other blended components and being sustainable (having slow releasing properties) with excellent dispersion stability. Such a reducing particle dispersion may include, for example, a dispersion in which reducing particles encapsulating at least one of reducing components selected from polyphenol(s), copper chlorophyll, flavonoid(s), anthocyanidin(s), dibutylhydroxytoluene, and butylhydroxyanisole, are dispersed in water. The reducing particles contain, as a main component, at least a polymer having a structural unit of formula (I) in a repeating unit:

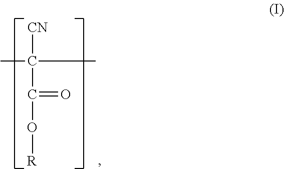

wherein R is an alkyl group having 2 to 8 carbons. The reducing particles preferably encapsulate a preservative component together with the reducing component.

### TECHNICAL FIELD

The present specification relates to a reducing particle dispersion that achieves both reduction performance on oxygen (oxygen absorbing ability) and preservative performance at a high level, and does not adversely affect other blended components and the like while being sustainable (having slow releasing properties) and excellent in dispersion stability.

### BACKGROUND ART

A wide variety of oxygen absorbing materials are known, and for each of the applications such as foods, drugs, pharmaceuticals, cosmetics, electronic parts, and inks, various kinds of oxygen absorbing materials including iron powder, catechol, ascorbic acid, and the like are known.

For example, known powdered oxygen absorbing materials include a powdered oxygen absorbing material containing a thermoplastic polymer (A) and an oxidation-promoting component (B), the thermoplastic polymer (A) having a Mooney viscosity of 10 to 400, and no crystalline melting peak or a melting point of less than 75° C. as measured with differential scanning calorimetry (DSC), and, containing allyl hydrogen and/or hydrogen bonded to tertiary carbon in the molecule, and the powdered oxygen absorbing material having a specific surface area of 60 cm²/g or more (see, for example, Patent Document 1). Also, known oxygen-absorbing particles include oxygen-absorbing particles containing an organic oxidable, a transition metal compound, inorganic particles, and an organic polymer, the inorganic particles being selected from inorganic porous particles and inorganic layered compound particles, in which at least a part of the organic oxidable and at least a part of the transition metal compound are present in pores or between layers of the inorganic particles, and, at least a part of the organic polymer covers at least a part of outer surfaces of the inorganic particles (see, for example, Patent Document 2).

However, the powdered oxygen absorbing materials and the like of Patent Documents 1 and 2 are mainly to be sealed in packaging bags for foods, drugs, pharmaceuticals, cosmetics, electronic components and the like, and while having reduction performances on oxygen (oxygen absorbing ability), those have issues such as persistence difficulties, and because those are not supposed to be used for liquids such as daily sanitary goods and the like, their usage is limited for such applications, and also other functions are not to be added.

On the other hand, an applicable composition for anti-wrinkle, whitening, anti-acne cosmetics, and the like is known, in which at least two groups are selected from the three groups including: a group consisting of metal redox catalysts selected from substances selected from iron, indium, tin, and cerium, compounds containing these substances, or oxides thereof; a group consisting of oxidoreductases selected from proteases, lipases, and amylases; and a group consisting of reducing agents selected from ascorbic acid, coenzyme Q10, flavonoids, and catechins, where at least two components are selected from the selected two groups, and the metal redox catalyst and the reducing agent or the oxidoreductase are crystallized and cross-linked metal redox catalyst and reducing agent or oxidoreductase, or metal redox catalyst or oxidoreductase conjugated onto an insoluble polymer, or particles, preferably micrometer or nanometer particles (see, for example, Patent Document 3).

Also a nanocapsule for pharmaceutical, cosmetic and/or nutritional active ingredients is known, the nanocapsule being characterized by containing a microemulsion of water in a liquid lipid, and containing at least one hydrophilic active ingredient dissolved in the internal aqueous phase, in which the nanocapsule is coated with a polymer selected from the group consisting of proteins, polysaccharides, polyester, polyacrylate, polycyanoacrylate, copolymer and/or mixtures thereof and the like (see, for example, Patent Document 4).

However, the particles, nanocapsules and the like disclosed in Patent Documents 3 and 4 have issues in that they are inferior in persistence (sustainable releasing properties) of reduction performance and the like as well as dispersion stability, and that they adversely affect other blended components and the like. In general, in a water-based liquid containing a reducing agent (antioxidant or the like) or the like, issues such as destabilization of a composition containing the reducing agent, destabilization of a dispersion system, physical gelation, or separation still occur. Furthermore, there are few reducing agents (antioxidants or the like) that themselves have preservative properties, and it has been necessary to use a reducing agent (an antioxidant or the like) and a preservative together in an aqueous liquid.

### CITATION LIST

### Patent Document

Patent Document 1: WO 2006/095640 A1 (Claims, Examples, and the like)
Patent Document 2: JP 2020-100801 A (Claims, Examples, and the like)
Patent Document 3: JP 2007-277212 A (Claims, Examples, and the like)
Patent Document 4: JP 2013-537206 A (Claims, Examples, and the like)

### DISCLOSURE OF INVENTION

### Technical Problem

In light of the above-mentioned issues and current state of the art, the present disclosure aims to solve such issues, and found that a reducing particle dispersion can be obtained, which achieves both reduction performance on oxygen (oxygen absorbing ability) and preservative performance at a high level, and does not adversely affect other blended components while being sustainable (having slow releasing properties) and excellent in dispersion stability. Based on such findings, the present disclosure was completed.

That is, the reducing particle dispersion of the present disclosure is characterized in that at least reducing particles comprising a polymer having a structural unit represented by General Formula (I) in a repeating unit as a main component, and encapsulating a reducing component are dispersed in water:

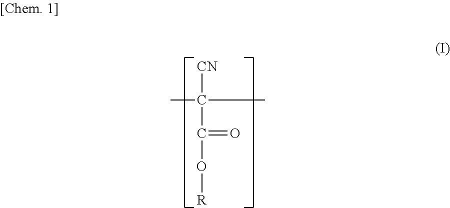

[where in General Formula (I) above, R represents an alkyl group having 2 to 8 carbons].

The reducing component encapsulated in the reducing particles is preferably at least one of reducing components selected from Group A below:

Group A: polyphenols, copper chlorophyll, flavonoids, anthocyanidins, dibutylhydroxytoluene, and butylhydroxyanisole.

The reducing component is preferably at least one selected from chlorogenic acid, tannin, catechin, piceatannol, dibutylhydroxytoluene, and butylhydroxyanisole.

The particles preferably have an average particle size of 10 to 800 nm.

The reducing particles preferably encapsulate a preservative component together with the reducing component.

### Advantageous Effects of Invention

According to the present disclosure, provided is a reducing particle dispersion that achieves both reduction performance on oxygen (oxygen absorbing ability) and preservative performance at a high level, does not adversely affect other blended components while being sustainable (having slow releasing properties) and excellent in dispersion stability.

The object and effects of the present disclosure can be recognized and obtained especially using the components and combinations indicated in the claims. Both general explanation described above and detailed explanation described below are exemplary and explanatory and do not limit the present disclosure described in Claims.

### DESCRIPTION OF EMBODIMENTS

Embodiments of the present disclosure will be described below in detail. However, note that the technical scope of the present disclosure is not limited to the embodiments described below and includes the invention described in Claims and equivalents thereof.

The reducing particle dispersion of the present disclosure is characterized in that at least reducing particles comprising a polymer having a structural unit represented by General Formula (I) in a repeating unit as a main component and encapsulating a reducing component are dispersed in water:

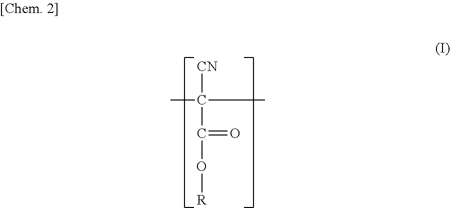

[where in General Formula (I) above, R represents an alkyl group having 2 to 8 carbons].

The reducing component for use in the present disclosure is not particularly limited as long as it has a reduction performance on oxygen (oxygen absorbing ability), and various reducing components can be used. Further, if there are commercially available products, such products (reducing components) can be used.

The reducing component is preferably at least one of reducing components selected from Group A below (a single reducing component or a mixture of two or more reducing components, the same applies hereinafter), in view of maximizing the effects of the present invention without impairing the properties of the polymer having the structural unit represented by General Formula (I) above in the repeating unit:

Group A: polyphenols, copper chlorophyll, flavonoids, anthocyanidins, dibutylhydroxytoluene (BHT), and butylhydroxyanisole (BHA).

Polyphenols that can be used are those having a phenolic molecule with multiple hydroxy groups. Examples of polyphenols, flavonoids, and anthocyanidins that can be used include catechins (epicatechin, epigallocatechin, epicatechin gallate, epigallocatechin gallate, etc.), tannic acid, tannin, chlorogenic acid, caffeic acid, neochlorogenic acid, cyanidin, proanthocyanidin, thearubidin, rutin, flavonoids (quercitrin, anthocyanin, flavanone, flavanol, flavonol, isoflavone, etc.), ferulic acid, gingerol, anthocyanidins (pelargodinin, cyanidin, delphinidin, peonidin, malvidin, petunidin), flavone, chalcones (naringenin chalcone, etc.), xanthophyll, carnosic acid, eriocitrin, nobiletin, tangeretin, magnolol, honokiol, ellagic acid, lignan, curcumin, coumarin, catechol, procyanidin, theaflavin, rosmarinic acid, xanthone, quercetin, resveratrol, gallic acid, propyl gallate, phlorotannin, piceatannol [5-(dihydroxyphenylethenyl)resorcin] (product name “Pasenol PA”), and resveratrol (3,5,4′-trihydroxy-trans-stilbene).

Particularly preferable reducing components include, from the viewpoint of reducing strength and safety, catechin, tannin, chlorogenic acid, piceatannol, copper chlorophyll, ferulic acid, curcumin, gingerol, rutin, anthocyanin, isoflavone, anthocyanidins (pelargodinin, cyanidin, delphinidin, peonidin, malvidin, petunidin), dibutylhydroxytoluene (BHT), butylhydroxyanisole (BHA), among which more preferable are chlorogenic acid, tannin, catechin, ferulic acid, piceatannol, dibutylhydroxytoluene (BHT) and butylhydroxyanisole (BHA).

The reducing particle dispersion of the present disclosure is a dispersion in which reducing particles encapsulating a reducing component are dispersed in water, and the reducing particles contain at least a polymer having the structural unit represented by General Formula (I) above in the repeating unit as a main component. The reducing particle dispersion of the present disclosure is preferably a dispersion in which reducing particles encapsulating at least one of reducing components selected from Group A above are dispersed in water, and the reducing particles contain, as a main component, at least a polymer having the structural unit represented by General Formula (I) above in the repeating unit. A method for producing these reducing particle dispersions includes, for example, by encapsulating the reducing component in shell of the polymer having the structural unit represented by General Formula (I) above in the repeating unit.

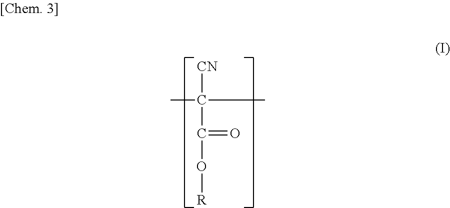

Examples of the alkyl group having 2 to 8 carbon atoms represented by R in General Formula (I) above include an ethyl group, a propyl group (linear or branched), a butyl group (linear or branched), a pentyl group (linear or branched), a hexyl group (linear or branched), a heptyl group (linear or branched), and an octyl group (linear or branched), among which preferable are an alkyl group having 4 carbon atoms and an octyl group having 8 carbon atoms, which are used as an adhesive for suturing a wound in a surgical region. An isobutyl group, a n-octyl group, and a 2-octyl group are particularly preferable.

Specifically, from the viewpoint of further exhibiting the effect of the present disclosure, it is desirable that at least one selected from isobutyl cyanoacrylate, n-butyl cyanoacrylate, tert-butyl cyanoacrylate, n-octyl cyanoacrylate, or 2-octyl cyanoacrylate is included.

The mass ratio of the shell-forming cyanoacrylate is preferably 90 to 100 mass % from the viewpoint of safety and stability.

In the particle of the present disclosure, the reducing component is encapsulated, and the shell is formed with the polymer of cyanoacrylate having the structure represented by General Formula (I) above in the repeating unit. In the particles, the cyanoacrylate itself adheres to cell walls of bacteria, interferes with cell wall synthesis, causes lysis, and inhibits the growth of bacteria (including mildew). Thus the cyanoacrylate alone has an antibacterial effect (antimicrobial properties/mildewproof properties). In addition, in the present disclosure, the reducing component itself encapsulated in the particles also has reduction performance on oxygen (oxygen absorbing ability) as described above. These components are highly compatible without adversely affecting the performance of each other. Regarding preservative performance, these components have high safety, a wide antibacterial spectrum, an excellent preservative effect (including antifungal effect), and excellent persistence (slow releasing properties). Regarding reduction performance on oxygen (oxygen absorbing ability), these components are sustainable (having slow release property). Thus, a reducing particle dispersion is obtained in which the reducing particles, while having these performances, have no adverse effect on other blended components, and has excellent dispersion stability are dispersed in water (these points will be described in detail in Examples and the like described later).

In the production of the particles, for example, when the structural unit (monomer) represented by General Formula (I) above is polymerized by anionic polymerization, the reducing component is added to cause the reducing component to be encapsulated (conjugated) in the particles, thereby producing an aqueous dispersion containing the particles.

A polymerization agent may be used to initiate the polymerization and stabilize the polymerization. Examples of the polymerization agent include at least one saccharide selected from the group consisting of polyoxyethylene sorbitan fatty acid esters, and monosaccharides and disaccharides having a hydroxyl group.

Examples of the polyoxyethylene sorbitan fatty acid ester that can be used include polyoxyethylene sorbitan laurate, polyoxyethylene sorbitan palmitate, polyoxyethylene sorbitan stearate, and polyoxyethylene sorbitan oleate.

The effect can be further enhanced by using a saccharide as a polymerization agent in addition to the polyoxyethylene sorbitan fatty acid ester.

The saccharide which can be used may be any saccharide as long as it is a monosaccharide or disaccharide having a hydroxyl group. Preferred examples thereof include glucose, mannose, ribose, fructose, maltose, trehalose, lactose and sucrose. These saccharides may be in any form of a cyclic form or a chain form, and in the case of a cyclic form, they may be in any form of a pyranose form or a furanose form. There are various isomers of saccharides and any of those may be used. Usually, a monosaccharide is present in a pyranose form or a furanose form, and a disaccharide is obtained by α-bonding or β-bonding of the monosaccharides. A saccharide in such a normal form can be used as it is. The monosaccharides and the disaccharides may be used alone or in combination of two or more thereof.

As a solvent for the polymerization reaction, water (distilled water, purified water, pure water, etc.) is usually used. Since anionic polymerization is initiated by hydroxyl ions, the pH of the reaction solution affects the rate of polymerization. When the pH of the reaction solution is high, the polymerization is fast due to the high concentration of hydroxyl ions. When the pH is low, the polymerization is slow. Usually, an appropriate rate of polymerization can be obtained under an acidic condition with a pH of approximately 2 to 4. The acid to be added to acidify the reaction solution is not particularly limited, but phosphoric acid, hydrochloric acid, acetic acid, phthalic acid, citric acid, or the like, which does not adversely affect the reaction, can be preferably used.

The concentration of the structural unit represented by the above-described Formula (I) in the polymerization reaction solution when the reaction is initiated is not particularly limited, but is usually approximately 0.1 to 10 mass %, and preferably approximately 1 to 5 mass %. The concentration of the polymerization agent in the polymerization reaction solution when the reaction is initiated (the total concentration when a plurality of polymerization agents are used) is not particularly limited, but is usually approximately 1 to 30 mass %, and preferably approximately 5 to 20 mass %. Further, the reaction temperature is not particularly limited, but it is convenient and preferable to carry out the reaction at room temperature. The reaction time is not particularly limited, but is usually approximately 0.5 to 4 hours. The polymerization reaction is preferably carried out under stirring. Since the particles are usually used as neutral particles, it is preferable to neutralize the reaction solution by adding a base such as an aqueous sodium hydroxide solution to the reaction solution as necessary after the completion of the reaction.

By the polymerization reaction, the structural unit represented by Formula (I) is anionically polymerized to produce polymer particles having the structure represented by Formula (I) in the repeating unit, and the reducing component is encapsulated (conjugated) inside the particles.

By encapsulating (conjugating) the above-described reducing component in the polymer particles having the structure represented by General Formula (I) above in the repeating unit, an unprecedented reducing particle dispersion is obtained, which achieves both reduction performance on oxygen (oxygen absorbing ability) and preservative performance at a high level, without adverse affection between the action of the antibacterial/mildewproof effect of the particle alone and the action of the reduction performance of the reducing component, and does not adversely affect other blended components and the like at the same time while being sustainable (having slow releasing properties) and excellent in dispersion stability.

In the present disclosure, from the viewpoint of achieving sufficient reduction performance on oxygen (oxygen absorbing ability), a slow reducing effect, stability, and the like, the content (solid content) of the reducing component is desirably 1 mass % or greater, preferably 5 mass % or greater, more preferably 10 to 50 mass %, and particularly preferably 15 to 40 mass %, based on the total of polymer components.

When the content of the reducing component is 1 mass % or more, sufficient reduction performance on oxygen (oxygen absorbing ability) and a sustainable reducing effect can be exhibited, while less than 1 mass % of the content of the reducing component may result in insufficient reduction performance on oxygen (oxygen absorbing ability), and as a result, the effect of the present disclosure cannot be exhibited.

The reducing particle dispersion (dispersion liquid) of the present disclosure is better than the simple reducing particle dispersion, because it has preservative performance while having strong reduction performance on oxygen (oxygen absorption ability), achieves these performances at a high level, does not adversely affect other blended components while being sustainable (having slow releasing properties) and excellent in dispersion stability, which is not found in conventional reducing particle dispersions.

In the present disclosure, with a view to further enhancing the preservative effect, a preservative component, together with the reducing component, may be encapsulated in the reducing particles.

In the reducing particles of the present disclosure, the shell is formed with the polymer of cyanoacrylate having the structure represented by General Formula (I) above in the repeating unit, and the cyanoacrylate itself has an antibacterial effect (antimicrobial properties/mildewproof properties) by itself. However, from the viewpoint of exhibiting a wider antibacterial spectrum and a preservative effect (including antifungal effect), a preservative component may be encapsulated together with the reducing component when the reducing particles are formed.

As the preservative component that can be used in the present disclosure, a known preservative component can be used. Preferably, the preservative component is highly safe and free of adverse affect, and has antibacterial and mildewproof properties over a long period of time. The preservative component is at least one selected from Group B below, for example.

Group B: an iodopropargyl compound, sodium pentachlorophenol, 1,2-benzisothiazolin-3-one, 2,3,5,6-tetrachloro-4(methylsulfonyl)pyridine, paraoxybenzoic acid ester, phenol, sodium benzoate, sodium dehydroacetate, potassium sorbate, morpholine, cresol, methylisothiazolinone, chloromethylisothiazolinone, octylisothiazolinone, dichlorooctylisothiazolinone, hexahydro-1,3,5-tris(2-hydroxyethyl)-1,3,5-triazine, 2-bromo-2-nitropropane-1,3-diol, sodium 2-pyridinethiol-1-oxide, sodium pyrithione, 2-(4-thiozolyl)benzimidazole, 4-terpineol, 1,8-cineol, thymol, diisothiocyanate, eucalyptus oil, longifolene, isopropylmethylphenol, 2-methyl-4-isothiazolin-3-one, citral, eugenol, allyl isothiocyanate, d-limonene, tannic acid, ethyl paraben, benzalkonium chloride, glyceryl caprylate, glycerin fatty acid ester, chlorphenesin, salicylic acid, ethyl paraoxybenzoate, butyl paraoxybenzoate, propyl paraoxybenzoate, methyl paraoxybenzoate, bisabolol, hinokitiol, phenylethyl alcohol, phenethyl alcohol, phenoxyethanol, butylparaben, propylparaben, benzalkonium chloride, methyl paraben, and 2-(4-thiazolyl)benzimidazole.

Among Group B above, the following components are desirable as more preferable preservative components, from the viewpoints of stability over time, relatively easy availability and low cost, and safety: an iodopropargyl compound, 1,2-benzisothiazolin-3-one, 2,3,5,6-tetrachloro-4(methylsulfonyl)pyridine, sodium benzoate, sodium dehydroacetate, potassium sorbate, cresol, methylisothiazolinone, chloromethylisothiazolinone, octylisothiazolinone, dichlorooctylisothiazolinone, hexahydro-1,3,5-tris(2-hydroxyethyl)-1,3,5-triazine, 2-bromo-2-nitropropane-1,3-diol, sodium 2-pyridinethiol-1-oxide, sodium pyrithione, 2-(4-thiozolyl)benzimidazole, 4-terpineol, 1,8-cineol, diisothiocyanate, isopropylmethylphenol, 2-methyl-4-isothiazolin-3-one, citral, eugenol, allyl isothiocyanate, D-limonene, tannic acid, ethyl paraben, benzalkonium chloride, glycerin fatty acid ester, salicylic acid, ethyl paraoxybenzoate, butyl paraoxybenzoate, propyl paraoxybenzoate, methyl paraoxybenzoate, hinokitiol, phenylethyl alcohol, phenethyl alcohol, phenoxyethanol, butylparaben, propylparaben, benzalkonium chloride, methyl paraben, and 2-(4-thiazolyl)benzimidazole.

The production of reducing particles containing a preservative component together with the reducing component can conform to the production of reducing particles containing the reducing component. The reducing particles can be produced by encapsulating the reducing component and the preservative component in the shell of the polymer having the structural unit represented by the above-described Formula (I) in the repeating unit. The structural unit represented by Formula (I) is anionically polymerized to produce polymer particles having the structure represented by Formula (I) in its repeating unit, and the reducing component and the preservative component are encapsulated (conjugated) in the particles.

When the reducing component and the preservative component are encapsulated (conjugated) in the polymer particles having the structure represented by the General Formula (I) in the repeating unit, an unprecedented reducing particle dispersion as follows can be obtained: the reducing particle dispersion that highly achieves both the reduction performance on oxygen (oxygen absorbing ability) and the preservative performance of the antibacterial effect (antimicrobial properties/mildewproof properties) of the cyanoacrylate itself as well as the preservative performance of the preservative component (hereinafter referred to as “composite preservative performance”), while the antibacterial and mildewproof effects of the particles alone, the preservative effect of the preservative component, and the reduction performance of the reducing component do not adversely affect one another. The reducing particle dispersion maintains its persistence (sustainable releasing properties) without adversely affecting other blended components, yet achieves excellent dispersion stability.

In the present disclosure, from the viewpoint of achieving sufficient composite preservative performance, a sustainable preservative effect, stability and the like, the content (solid content) of the preservative component is desirably 0.1 mass % or more, preferably 0.5 mass % or more, more preferably 1 to 40 mass %, and particularly preferably 3 to 30 mass %, based on the total of polymer components.

When the content of the preservative component is 0.1 mass % or more, sufficient composite preservative performance and a sustainable preservative effect can be exhibited. On the other hand, when the content of the preservative component is less than 0.1 mass %, a poor effect of encapsulating the preservative component is exhibited.

In addition, in the present disclosure, the average particle size of the resulting reducing particles (with reducing component being encapsulated, or with reducing component and preservative component being encapsulated, the same applies hereinafter) varies depending on the monomer having the structural units of General Formula (I) above, the content, polymerization conditions during polymerization, etc., however, preferably the average particle size thereof is 10 to 800 nm, more preferably 20 to 400 nm, and still more preferably 30 to 200 nm.

When the average particle size is in the above preferable range, the particle dispersion can be suitably used for various applications while achieving excellent storage stability.

Note that the “average particle size” prescribed in the present disclosure is a histogram average particle size based on scattered light intensity distribution. In the present disclosure (including Examples described below), it is a value of D50 measured with a particle size distribution measuring equipment [FPAR1000 (available from Otsuka Electronics Co., Ltd.)].

In the reducing particle dispersion of the present disclosure, the contained particles having the above-described characteristics achieve both reduction performance on oxygen (oxygen absorbing ability) and preservative performance (including composite preservative performance) at a high level, do not adversely affect other blended components while being sustainable (having slow releasing properties), and have excellent dispersion stability. The preservative effect (including mildewproof effect) can be applied against many bacteria such as Gram-negative bacteria and Gram-positive bacteria and mildew. The preservative performance (including composite preservative performance) and the reduction performance are also sustainable for a long time.

The reducing particle dispersion of the present disclosure configured as described above can be used to impart the preservative performance and the reduction performance to various products such as medical devices, baby products, nursing products, bath products, kitchen utensils, tableware, drinking water piping parts, daily hygiene products, household electrical appliances, clothing, building materials, agricultural materials, automobile interior parts, stationery, and ink compositions for writing instruments and inkjet printers.

In addition to the above-described applications, as specific applications, the reducing particle dispersion can be suitably used for detergents such as a laundry detergent, a softener, a household detergent, a dish detergent, and a detergent for a hard surface; personal care applications such as a shampoo, a rinse, a skin lotion, a milky lotion, a cream, a sunscreen, a foundation, an eye makeup product, an antiperspirant, and a toothpaste; industrial water treatment applications such as a boiler, cooling equipment, waste water treatment equipment, and industrial water (papermaking process water in a papermaking process, cooling water and washing water for various industries); a medical instrument, a food additive, and electronic devices such as a solar cell module, an organic device, and a heat-ray shielding film; and a water tank and a chemical bath for suppressing water mildew on aquatic organisms (such as fish).

Furthermore, the form and the like when the reducing particle dispersion of the present disclosure is used in an aqueous ink composition for writing instruments such as felt-tip pens, marking pens, and ballpoint pens will be described in detail below.

The aqueous ink composition for writing instruments according to the present disclosure includes at least the reducing particle dispersion having the above-described configuration, and can contain a colorant and a water-soluble organic solvent in addition to the reducing particle dispersion.

The content of the reducing particles in the ink composition is preferably 0.1 to 30.0 mass %, and more preferably 1.0 to 15.0 mass % in terms of solid content with respect to the total amount of the ink composition, from the viewpoint of exhibiting the effect of the present disclosure without impairing writing performance and from the viewpoint of storage stability.

As the colorant that can be used, for example, a water-soluble dye, a pigment such as an inorganic pigment, an organic pigment, a plastic pigment, hollow resin particles having voids within the particles that are used as a white pigment, resin particles (pseudo-pigment) dyed with a dye having excellent color development and dispersibility, or the like can be used.

For the water-soluble dye, a direct dye, an acid dye, an edible dye, or a basic dye can be used in an appropriate amount within a range in which the effects of the present disclosure would not be impaired.

The content of the colorant varies depending on the type of the writing instrument, and is 1 to 30 mass % with respect to the total amount of the ink composition.

The water-soluble organic solvent that can be used includes, for example, at least one of alkylene glycols such as ethylene glycol, triethylene glycol, tetraethylene glycol, propylene glycol, dipropylene glycol, 1,2-propanediol, 1,3-propanediol, 1,2-butanediol, 2,3-butanediol, 1,3-butanediol, 1,4-butanediol, 1,2-pentanediol, 1,5-pentanediol, 2,5-hexanediol, 3-methyl-1,3-butanediol, 2-methylpentane-2,4-diol, 3-methylpentane-1,3,5-triol, and 1,2,3-hexanetriol; polyalkylene glycols such as polyethylene glycol and polypropylene glycol; glycerols such as glycerol, diglycerol, and triglycerol; lower alkyl ethers of glycols such as ethylene glycol monomethyl ether, ethylene glycol monoethyl ether, diethylene glycol monomethyl ether, diethylene glycol monoethyl ether, and diethylene glycol mono-n-butyl ether; N-methyl-2-pyrrolidone, or 1,3-dimethyl-2-imidalizinone.

In addition, water-soluble solvents such as alcohols such as methyl alcohol, ethyl alcohol, isopropyl alcohol, n-butyl alcohol, tert-butyl alcohol, isobutyl alcohol, hexyl alcohol, octyl alcohol, nonyl alcohol, decyl alcohol, benzyl alcohol, and amides such as dimethylformamide and diethylacetamide, and ketones such as acetone may also be mixed.

The content of these water-soluble organic solvents varies depending on the kind of writing instruments such as felt-tip pens, marking pens, and ballpoint pens, and is 1 to 40 mass % based on the total amount of the ink composition. The ink composition in which the content of the solvent is 10 mass % or less is particularly effective in terms of further improving a drying property of the drawn lines, and it is desired that the content is more preferably 3 to 8 mass %.

Besides the particles having the characteristics described above, the colorant, and the water-soluble solvent, the aqueous ink composition for writing instruments of the present disclosure can appropriately contain, as the balance, water as a solvent (e.g., tap water, purified water, distilled water, ion exchanged water, or pure water) as well as a dispersant, a lubricant, a pH adjuster, a corrosion inhibitor, a thickener, an evaporation inhibitor, a surfactant, a fixing agent, or the like, within a range in which the effects of the present disclosure are not be impaired.

Examples of the dispersant that can be used include nonionic and anionic surfactants, and water-soluble resins. Preferably, water-soluble polymers are used.

Examples of the lubricant include, but are not limited to, non-ionic types such as fatty acid esters of polyhydric alcohols, higher fatty acid esters of sugars, polyoxyalkylene higher fatty acid esters, and alkyl phosphate esters; anionic types such as alkyl sulfonates of higher fatty acid amides and alkyl allyl sulfonates; derivatives of polyalkylene glycols, fluorochemical surfactants, and polyether modified silicones, which are also used as surface treating agents for pigments.

Examples of the pH adjuster include ammonia, urea, monoethanolamine, diethanolamine, triethanolamine, alkali metal salts of carbonic acid and phosphoric acid such as sodium tripolyphosphate and sodium carbonate, and alkali metal hydroxides such as sodium hydroxide. Examples of the corrosion inhibitor include benzotriazole, tolyltriazole, dicyclohexylammonium nitrite, and saponins.

Examples of the thickener include cellulose derivatives such as carboxymethylcellulose (CMC) or salts thereof, fermented cellulose, and crystalline cellulose, as well as polysaccharides. Examples of the polysaccharides that can be used include xanthan gum, guar gum, hydroxypropylated guar gum, casein, gum arabic, gelatin, amylose, agarose, agaropectin, arabinan, curdlan, callose, carboxymethyl starch, chitin, chitosan, quince seed, glucomannan, gellan gum, tamarind seed gum, dextran, nigeran, hyaluronic acid, pustulan, furoran, HM pectin, porphyran, laminaran, lichenan, carrageenan, alginic acid, tragacanth gum, alkasy gum, succinoglycan, locust bean gum, and tara gum. These polysaccharides may be used alone, or two or more thereof may be used in combination. Commercially available products of these, if present, can be used.

Examples of the vaporization inhibitor include pentaerythritol, p-xylene glycol, trimethylolpropane, triethylolpropane, and dextrin.

Examples of the surfactant include fluorine-based, silicone-based, and acetylene glycol-based surfactants.

Examples of the fixing agent include at least one selected from water-soluble resins having a hydrophobic part in the molecule such as polyacrylic acid, water-soluble styrene-acrylic resin, water-soluble styrene-maleic acid resin, polyvinyl alcohol, polyvinyl pyrrolidone, water-soluble maleic acid resin, water-soluble styrene resin, polyvinyl pyrrolidone, polyvinyl alcohol, water-soluble ester-acrylic resin, ethylene-maleic acid copolymer, polyethylene oxide, and water-soluble urethane resin, and resin emulsions such as polyolefin-based emulsion, acrylic emulsion, vinyl acetate-based emulsion, urethane-based emulsion, styrene-butadiene emulsion and styrene-acrylonitrile emulsion may be used, and it is desirable to use two or more of them in total, one or more of them for each.

The aqueous ink composition for writing instruments of the present disclosure can be prepared by appropriately combining the particles having the characteristics described above, the water-soluble solvent, and other components, depending on the application of the aqueous ink composition for writing instruments (e.g., for a ballpoint pen, a marking pen), and then mixing those by stirring using a stirrer such as a homomixer, a homogenizer, or a disperser, and, as necessary, further filtering or centrifuging the mixture to remove coarse particles in the ink composition.

In addition, a pH level of the aqueous ink composition for writing instruments of the present disclosure (at 25° C.) is adjusted to preferably 5 to 10, further preferably 6 to 9.5, by using a pH adjuster or the like from the perspective of usability, safety, stability of the ink itself, and matching with the ink container.

The aqueous ink composition for writing instruments of the present disclosure is loaded in a ballpoint pen, a marking pen, or the like provided with a pen tip such as a ballpoint pen tip, a fiber tip, a felt tip, or a plastic tip.

The ballpoint pen includes an instrument where the aqueous ink composition for writing instruments having the above-mentioned composition is accommodated in an ink container (refill) for a ballpoint pen having a ball with a diameter of 0.18 mm to 2.0 mm, and where a material which is not compatible with the aqueous ink composition accommodated in the ink container and which has a small specific gravity with respect to the aqueous ink composition, for example, polybutene, silicone oil, and mineral oil is accommodated as an ink follower.

Note that the structures of the ballpoint pen and the marking pen are not particularly limited, and the ballpoint pen and the marking pen may be, for example, a direct liquid type pen provided with a collector structure (ink holding mechanism) using a shaft cylinder itself as an ink container in which the shaft cylinder is filled with the aqueous ink composition for writing instruments having the configuration described above.

In the aqueous ink composition for writing instruments of the present disclosure configured as described above, the reducing particle dispersion having the characteristics described above is blended in the aqueous ink composition for writing instruments. Thus, the reducing particles achieve both reduction performance on oxygen (oxygen absorbing ability) and preservative performance (including composite preservative performance) at a high level in the ink composition, do not adversely affect other blended components of ink or the like while being sustainable (having slow releasing properties), and moreover, has excellent dispersion stability even in an ink blend composition. The reducing particles therefore can suppress the generation of bubbles, and maintain the persistence effect for a long period of time. In addition, these particles do not impair the storage stability and the writing performance, which can further enhance a degree of freedom in ink design. Accordingly, it is possible to obtain an aqueous ink composition for writing instruments suitable for writing instruments such as a ballpoint pen and a marking pen.

### EXAMPLES

Next, the present disclosure will be described in more detail using Examples and Comparative Examples, but the present disclosure is not limited to the following Examples.

### Examples 1 to 9: Production of Reducing Particle Dispersions A to I

Reducing particle dispersions A to I were produced by the following Examples 1 to 9. Note that the term “parts” below refers to parts by mass.

### Example 1: Production of Reducing Particle Dispersion A

A 2-liter flask was equipped with a stirrer, a reflux condenser, and a thermometer, set in a water tank. In the flask, 93.8 parts of distilled water, 2 parts of polyoxyethylene sorbitan monolaurate (20E.O.), and 0.2 parts of phosphoric acid, 4 parts of a monomer in which R in Formula (I) is isobutyl (isobutyl cyanoacrylate), and 2 parts of chlorogenic acid as a reducing component were placed, and stirred for about 15 minutes to complete anionic polymerization to form an antibacterial particle dispersion A. The particles had an average particle size of 85 nm.

### Examples 2 to 6: Production of Particles B to F

Reducing particle dispersions B to F were obtained in the same manner as in Example 1 with the blending compositions indicated in Table 1 below, respectively. Respective average particle sizes of the particles are indicated in Table 1 below.

### Examples 7 to 9: Production of Particles G to I

Reducing particle dispersions G to I were obtained, using the reducing components and the preservative components in the same manner as in Example 1 with the blending compositions indicated in Table 1 below, respectively. Respective average particle sizes of the particles are indicated in Table 1 below.

The solid contents of the reducing particles in the respective reducing particle dispersions obtained in Examples 1 to 9 were 35 to 40 mass %.

Using the reducing particle dispersions (dispersion liquids) of Examples 1 to 9 obtained above, the persistence of the reduction performance (ability to remove dissolved oxygen), the dispersion stability, and the preservative performance were evaluated by the following evaluation methods.

As Reference Example 1, a reducing dispersion (dispersion liquid: chlorogenic acid liquid) was used.

These results are indicated in Table 1 below.

### (Method for Evaluating Reduction Performance)

The reduction performance was evaluated by measuring the amount of dissolved oxygen using the reducing particle dispersions (dispersion liquids) of Examples 1 to 9 and Reference Example 1 obtained above. For the evaluation, a dissolved oxygen meter: WQ-320 (available from Horiba, Ltd.) was used, and after the preparation of the reducing particle dispersion, the reducing particle dispersion was allowed to stand at a temperature of 25° C., for a storage period of 48 hours and 3 months, and the persistence of the reduction performance measured at a measurement temperature of 25° C. was evaluated according to the following evaluation criteria.

### Evaluation Criteria:

A: The amount of dissolved oxygen was 0.1 mg/L or more and less than 10 mg/L.
B: The amount of dissolved oxygen was 10 mg/L or more and less than 20 mg/L.
C: The amount of dissolved oxygen was 20 mg/L or more.

### (Method for Evaluating Dispersion Stability)

Each of the aqueous reducing particle dispersions, 10 ml, obtained using the reducing dispersions (dispersion liquids) of Examples 1 to 9 and Reference Example 1 obtained above was filled in a 15 ml glass bottle with a cap together with a stirring ball (φ6.4 mm, made of stainless steel), sealed, stored for 1 month under the condition of 40° C. with the cap facing upward, and then shaken. The dispersion stability was evaluated by the number of times of shaking until the stirring ball started to move in the glass bottle with a lid according to the following evaluation criteria.

### Evaluation Criteria:

A: 0 to 3 times.
B: 4 to 10 times.
C: 11 times or more.
* 0 times: Movement of the stirring ball was observed when the glass bottle with a lid was tilted.

### (Test Method for Preservative Effects (Antimicrobial and Mildewproof Properties))

Using the reducing particle dispersions (dispersion liquids) of Examples 1 to 9 and Reference Example 1 obtained above, evaluation was performed by the following microbial testing method in accordance with ISO 11930:2012 (Procedure for Interpretation of Data Generated by Preservative Efficacy Testing or Microbiological Risk Assessment, or both).

The challenge test was performed by using the three groups including the bacterial flora, the yeast, and the filamentous fungus described below.

Bacterial group: Staphylococcus aureus NBRC13276, Escherichia coli NBRC3972

Yeast: Candida albicans NBRC1594

Filamentous fungus: Aspergillus brasiliensis

### Preparation of Inocula

Preparation of inoculum: Bacterial cultures were prepared in accordance with ISO 11930:2012.

Bacterial flora: Each bacterial culture was prepared in accordance with ISO 11930:2012 for each bacterial strain. Three types of the bacterial cultures, each of which has its bacterial strain adjusted to 1×10⁷ to 1×10⁸ cfu/mL, were mixed using equal amounts, and thus an inoculum was prepared.

Yeast: In accordance with ISO 11930:2012, a bacterial culture was prepared to be 1×10⁶ to 1×10⁷ cfu/mL.

Filamentous fungus: In accordance with ISO 11930:2012, a bacterial culture was prepared to be 1×10⁶ to 1×10⁷ cfu/mL.

### <Inoculation>

For each of the dispersion liquids, 1 mass % of a bacterial culture was inoculated.

<Storage> The inoculated ink composition for writing instruments was stored at temperature of 22.5±2.5° C., and growth and decay of the inoculated microorganisms over time was observed for a designated period of time by detection culture.

### <Detection Culture>

A total of 1 g was coated on 10 sheets of SCD agar media for the bacterial flora, SD agar media for the yeast, and PD agar media for the filamentous fungus, and the bacterial flora and the yeast were cultured at 32.5° C. for 2 days, and the filamentous fungus was cultured for 22.5° C. for 5 days.

### <Evaluation Criteria>

A+: Colonies did not appear at day 3.
A: Colonies did not appear at day 7.
B: Colonies did not appear at day 21.
C: Several to tens of colonies emerged at day 28.
D: Obvious increase was observed at day 28.

TABLE 1
(Total amount of aqueous dispersion: 100 mass %)

| | | | | | | | | | | | Reference |
|---|---|---|---|---|---|---|---|---|---|---|---|
| | | Examples | | | | | | | | | Example |
| | | 1 | 2 | 3 | 4 | 5 | 6 | 7 | 8 | 9 | 1 |
| Aqueous reducing particle dispersion | | A | B | C | D | E | F | G | H | I | — |
| Cyanoacrylate species | iso-Butyl | 4 | | | | | | 4 | | | |
| [structure R in | n-Butyl | | 4 | | | | | | 4 | | |
| Formula (I)] | tert-Butyl | | | 4 | | | | | | 4 | |
| | Ethyl | | | | 4 | | | | | | |
| | n-Propyl | | | | | 4 | | | | | |
| | n-Octyl | | | | | | 4 | | | | |
| | 2-octyl | | | | | | | | | | |
| Reducing component | Chlorogenic acid | 2 | | | | | | 1.3 | | | 2 |
| | Tannin | | 2 | | | | | | 1.3 | | |
| | Catechin | | | 2 | | | | | | 1.3 | |
| | Piceatannol | | | | 2 | | | | | | |
| | Dibutylhydroxytoluene | | | | | 2 | | | | | |
| | Butylhydroxyanisole | | | | | | 2 | | | | |
| Preservative | Phenoxyethanol (*1) | | | | | | | 0.7 | | | |
| component | Methylisothiazoline (*2) | | | | | | | | 0.7 | | |
| | Benzisothiazolinone (*3) | | | | | | | | | 0.7 | |
| Acid | Phosphoric acid | 0.2 | 0.2 | 0.2 | 0.2 | 0.2 | 0.2 | 0.2 | 0.2 | 0.2 | |
| Emulsifior | Polyoxyothylono sorbitan | 2 | 2 | 2 | 2 | 2 | 2 | 2 | 2 | 2 | |
| | monopalmitato (20E.O.) | | | | | | | | | | |
| Water (distilled water) | | 91.8 | 91.8 | 91.8 | 91.8 | 91.8 | 91.8 | 91.8 | 91.8 | 91.8 | 98 |
| Average particle size (nm) | | 85 | 80 | 119 | 130 | 89 | 67 | 78 | 101 | 95 | — |
| Reduction performance after 48 hours (*4) | | A | A | A | A | A | A | A | A | A | B |
| Persistence of reduction performance after 3 months | | A | A | A | A | A | A | A | A | A | C |
| Dispersion stability | | A | A | A | A | A | A | A | A | A | B |
| Preservative | Bacterial flora | A | A | A | A | A | A | A+ | A+ | A+ | C |
| performance | Yeast | A | A | A | A | A | A | A+ | A+ | A+ | C |
| | Filamentous fungus | A | A | A | A | A | A | A+ | A+ | A+ | C |

(*1) Available from Yokkaichi Chemical Co., Ltd.
(*2) Available from Yamato Chemical Co., Ltd.
(*3) Available from Yamato Chemical Co., Ltd.
(*4) Amount of dissolved oxygen

As is apparent from the results in Table 1 above, it was found that the reducing particle dispersions (dispersion liquids) of Examples 1 to 9 obtained above achieved both reduction performance on oxygen (oxygen absorbing ability) and preservative performance at a high level, do not adversely affect other blended components and the like while being sustainable (having slow releasing properties), and have excellent dispersion stability.

In addition, it was confirmed that the reducing particle dispersions (dispersion liquids) of Examples 7 to 9, which further encapsulated a preservative component together with the reducing component in order to enhance the preservative effect, had further enhanced preservative performance as compared with the reducing particle dispersions (dispersions) encapsulating the reducing components of Examples 1 to 6, without adversely affecting the persistence effect, other blended components and the like, and had excellent dispersion stability.

### Examples 10 to 18 and Comparative Examples 1 to 3: Preparation of Aqueous Ink Composition for Writing Instruments

The respective reducing particle dispersions (dispersion liquids) obtained in Examples 1 to 9 were obtained, as Examples 10 to 18. The solid contents of the reducing particles in the respective reducing particle dispersions obtained in Examples 1 to 9 were 35 to 40 mass %.

On the other hand, the following three types of known oxygen absorbents were used for Comparative Examples 1 to 3.

In Comparative Example 1, sodium L-ascorbate was used, in Comparative Example 2, N-acetyl-cysteine was used, and in Comparative Example 3, an oligomer of N-vinyl-2-pyrrolidone (polymerization degree: 2 to 6) was used.

Each of the dispersion liquids of reducing particle dispersions (particles A to I) produced in Examples 1 to 9, and Comparative Examples 1 to 3 were used to prepare each of the aqueous ink compositions for writing instruments by an ordinary method according to the blend composition (total amount: 100 mass %) described below.

Ink composition (Total amount: 100 mass %)

| | | |
|---|---|---|
| Each of the reducing particle dispersions | 15.0 | mass % |
| (particles A to F) or Comparative Examples 1 to 3 | | |
| Colorant (carbon black MA100, available | 5.4 | mass % |
| from Mitsubishi Chemical Corporation) | | |
| pH modifier (triethanolamine) | 1.4 | mass % |
| Water-soluble organic solvent (propylene glycol) | 15.0 | mass % |
| Thickener (Xanthan gum) | 0.2 | mass % |
| Ion exchanged water | 63.0 | mass % |

The obtained aqueous ink compositions for writing instruments (total amount: 100 mass %) were evaluated for writing performance (vertical line density difference), the bubble generation situation after the lapse of time, and the bubble generation situation after giving an impact, by writing instruments A and B having the following configurations and the following evaluation method.

The evaluation results of Examples 10 to 18 and Comparative Examples 1 to 3 are indicated in Table 2 below.

### (Preparation of Writing Instrument: Ballpoint Pen)

Using a shaft of a cap type ballpoint pen A [trade name: Signo UM-100, available from Mitsubishi Pencil Co., Ltd.], a refill including an ink storage tube made of polypropylene having an inner diameter of 4.0 mm and a length of 113 mm, a stainless steel tip (cemented carbide ball, ball diameter: 0.5 mm) and a joint connecting the storage tube and the tip was filled with the aqueous ink compositions described above, and an ink follower composed mainly of a mineral oil was inserted at the rear end of the ink, thus preparing an aqueous ballpoint pen.

Using a shaft of a retractable ballpoint pen B [trade name: Signo UMN152, available from Mitsubishi Pencil Co., Ltd.], a refill including an ink storage tube made of polypropylene having an inner diameter of 4.0 mm and a length of 113 mm, a stainless steel tip (cemented carbide ball, ball diameter: 0.5 mm) and a joint connecting the storage tube and the tip was filled with the aqueous ink compositions described above, and an ink follower composed mainly of a mineral oil was inserted at the rear end of the ink, thus preparing a retractable aqueous ballpoint pen.

### [Method for Evaluating Writing Performance (Vertical Line Density Difference)]

Each aqueous ballpoint pen A having the above-described configuration was left to stand at room temperature (25° C., the same applies hereinafter) for one month, and then writing was performed up to the final writing point, and the difference in density of the drawn line at the start of writing and at the end of writing was compared and evaluated according to the following evaluation criteria.

### Evaluation Criteria:

A: No difference in density is observed.
B: A slight difference in density is observed.
C: A difference in density is clearly observed.
D: A difference in density is remarkable, and a portion where the drawn line is difficult to be visually recognized is observed.
   <Method for Evaluating Bubble Generation Situation after Lapse of Time>

Each ballpoint pen A having the above-described configuration was stored with the pen tip facing downward in an atmosphere of 50° C. and 30% RH for one month, and after the above-described period of time, the ballpoint pen A was left to stand with the pen tip facing downward at room temperature for 6 hours. Then, air bubbles appearing at an interface between the ink and the ink follower were visually confirmed, and evaluation was performed according to the evaluation criteria indicated below.

<Method for Evaluating Bubble Generation after Giving Impact>

Each retractable ballpoint pen B having the above-described configuration was knocked 5 times with the pen point facing downward, then stored with the pen tip facing downward in an atmosphere of 50° C. and 30% RH for one week, and after the above-described period of time, the ballpoint pen A was left to stand with the pen tip facing downward at room temperature for 6 hours. Then, air bubbles appearing at an interface between the ink and the ink follower were visually confirmed, and evaluation was performed according to the evaluation criteria indicated below.

### Evaluation Criteria:

A: No bubbles are present at the interface between the ink and the ink follower.
B: One bubble having a diameter smaller than 1 mm is present at the interface between the ink and the ink follower.
C: One or more bubbles having diameters equal to or larger than 1 mm or two or more bubbles having diameters smaller than 1 mm are present at the interface between the ink and the ink follower.
D: The ink follower is pushed up by bubbles, and a gap is present between the ink follower and the ink interface.

### <Method for Evaluating Preservative Performance>

With respect to each of the obtained aqueous ink compositions for writing instruments (total amount: 100 mass %), evaluation was performed by the following microbial testing method in accordance with ISO 11930:2012 (Procedure for Interpretation of Data Generated by Preservative Efficacy Testing or Microbiological Risk Assessment, or both).

The challenge test was performed by using the three groups including the bacterial flora, the yeast, and the filamentous fungus described below.

Bacterial group: Staphylococcus aureus NBRC13276, Escherichia coli NBRC3972

Yeast: Candida albicans NBRC1594

Filamentous fungus: Aspergillus brasiliensis

### <Preparation of Inocula>

Preparation of inoculum: Bacterial cultures were prepared in accordance with ISO 11930:2012.

Bacterial flora: Each bacterial culture was prepared in accordance with ISO 11930:2012 for each bacterial strain. Three types of the bacterial cultures, each of which has its bacterial strain adjusted to 1×10⁷ to 1×10⁸ cfu/mL, were mixed using equal amounts, and thus an inoculum was prepared.

Yeast: In accordance with ISO 11930:2012, a bacterial culture was prepared to be 1×10⁶ to 1×10⁷ cfu/mL.

Filamentous fungus: In accordance with ISO 11930:2012, a bacterial culture was prepared to be 1×10⁶ to 1×10⁷ cfu/mL.

### <Inoculation>

For the ink composition for writing instruments, 1 mass % of a bacterial culture was inoculated.

### <Storage>

The inoculated ink composition for writing instruments was stored at temperature of 22.5±2.5° C., and growth and decay of the inoculated microorganisms over time was observed for a designated period of time by detection culture.

### <Detection Culture>

A total of 1 g was coated on 10 sheets of SCD agar media for the bacterial flora, SD agar media for the yeast, and PD agar media for the filamentous fungus, and the bacterial flora and the yeast were cultured at 32.5° C. for 2 days, and the filamentous fungus was cultured for 22.5° C. for 5 days.

### <Evaluation Criteria>

A+: Colonies did not appear at day 3.
A: Colonies did not appear at day 7.
B: Colonies did not appear at day 21.
C: Several to tens of colonies emerged at day 28.
D: Obvious increase was observed at day 28.

TABLE 2
[Ink Composition for Writing Instruments]

| | | | | | | | | | | | Comparative | | |
|---|---|---|---|---|---|---|---|---|---|---|---|---|---|
| | | Examples | | | | | | | | | Examples | | |
| | | 10 | 11 | 12 | 13 | 14 | 15 | 16 | 17 | 18 | 1 | 2 | 3 |
| Reducing Particle Disporsion | | 1 | 2 | 3 | 4 | 5 | 6 | 7 | 8 | 9 | — | — | — |
| (Example No.) | | | | | | | | | | | | | |
| Occurrence of aggregation | | A | A | A | A | A | A | A | A | A | C | C | B |
| writing performance: vertical | | | | | | | | | | | | | |
| line density difference) | | | | | | | | | | | | | |
| Bubble generation situation | | A | A | A | A | A | A | A | A | A | B | B | B |
| after lapse of time | | | | | | | | | | | | | |
| Bubble generation situation | | A | A | A | A | A | A | A | A | A | C | C | C |
| after giving impact | | | | | | | | | | | | | |
| Preservative | Bacterial flora | A | A | A | A | A | A | A+ | A+ | A+ | C | C | C |
| performance | Yeast | A | A | A | A | A | A | A+ | A+ | A+ | C | C | C |
| | Filamentous fungus | A | A | A | A | A | A | A+ | A+ | A+ | C | C | C |

In considering Table 2 above, it has been confirmed that, as compared with to Comparative Examples 1 to 3, which fall outside the scope of the present disclosure, Examples 10 to 18, which fall within the scope of the present disclosure, are writing performance (vertical line density difference), no bubble is generated even after the lapse of time, no bubble is generated even after giving an impact, and other blended components of the ink are not adversely affected while strength and persistence of reduction performance on oxygen (oxygen absorbing ability) is maintained.

It also has been confirmed that the ballpoint pens A and B prepared above do not cause starving and feathering, and have a sufficient drawn line concentration to give a sharp drawn line.

In addition, it was confirmed that the aqueous ink compositions for writing instruments using the reducing particle dispersions (dispersion liquids) of Examples 16 to 18, which further encapsulated a preservative component together with the reducing component in order to enhance the preservative effect, had further enhanced preservative performance as compared with the reducing particle dispersions (dispersions) encapsulating the reducing components of Examples 10 to 15, without adversely affecting the persistence effect, other blended components and the like, and had excellent dispersion stability.

### INDUSTRIAL APPLICABILITY

The reducing particle dispersion of the present disclosure have strength and persistence (sustainable releasing properties) of reduction performance on oxygen (oxygen absorbing ability), do not adversely affect other blended components and the like, and moreover, have excellent dispersion stability and the preservative properties. The reducing particle dispersions therefore can be used to impart reducing properties and preservative properties to various products such as medical devices, baby products, nursing products, bath products, kitchen utensils, tableware, drinking water piping parts, daily hygiene products, household electrical appliances, clothing, building materials, agricultural materials, automobile interior parts, stationery, and ink compositions for writing instruments and inkjet printers.

1. A reducing particle dispersion, comprising:
water; and
reducing particles comprising a polymer having a structural unit of formula (I) in a repeating unit as a main component: 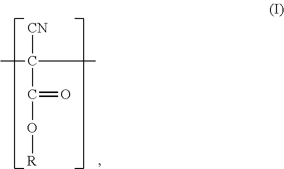
R being an alkyl group having 2 to 8 carbons,
wherein the reducing particles encapsulate a reducing component and are dispersed in the water.

2. The dispersion of claim 1, wherein the reducing component, encapsulated in the reducing particles, is at least one reducing component selected from
a polyphenol, copper chlorophyll, flavonoids, anthocyanidin, dibutylhydroxytoluene, butylhydroxyanisole.

3. The dispersion of claim 1, wherein the reducing particles have an average particle size in a range of from 10 to 800 nm.

4. The dispersion of claim 1, wherein the reducing component is at least one selected from chlorogenic acid, tannin, catechin, piceatannol, dibutylhydroxytoluene, and butylhydroxyanisole.

5. The reducing particle dispersion of claim 1, wherein the reducing particles encapsulate a preservative component together with the reducing component.

6. The dispersion of claim 1, wherein the reducing component comprises a polyphenol.

7. The dispersion of claim 1, wherein the reducing component comprises copper chlorophyll.

8. The dispersion of claim 1, wherein the reducing component comprises a flavonoid.

9. The dispersion of claim 1, wherein the reducing component comprises an anthocyanidin.

10. The dispersion of claim 1, wherein the reducing component comprises dibutylhydroxytoluene.

11. The dispersion of claim 1, wherein the reducing component comprises butylhydroxyanisole.

12. The dispersion of claim 1, wherein the reducing component comprises chlorogenic acid.

13. The dispersion of claim 1, wherein the reducing component comprises tannin.

14. The dispersion of claim 1, wherein the reducing component comprises catechin.

15. The dispersion of claim 1, wherein the reducing component comprises piceatannol.
